(19) United States
(12) Patent Application Publication
(10) Pub. No.: US 2026/0243492 A1
(43) Pub. Date: Aug. 20, 2026

(54) Refrigeration Unit

(71) Applicant: Nicholas Planson, New Gloucester, ME (US)

(72) Inventor: Nicholas Planson, New Gloucester, ME (US)

(21) Appl. No.: 19/053,605

(22) Filed: Feb. 14, 2025

(51) Int. Cl. F25D 11/00; F25D 23/06; F25D 29/00; H02S 99/00

(52) U.S. Cl. CPC F25D 11/003; F25D 23/066; F25D 23/067; F25D 29/003; F25D 2400/02; F25D 2400/361; H02S 99/00

(57) ABSTRACT

A solar powered refrigeration unit is provided. The refrigeration unit includes a sophisticated sensor system for operation tracking, location tracking, and operational data gathering. Refrigeration unit charge and operational statistics may be monitored and gathered. The solar powered refrigeration unit allows refrigeration of, for example, seafood in remote locations such as at sea using clean energy.

### BACKGROUND OF THE INVENTION

The present disclosure relates generally to solar powered refrigeration units. More particularly, the present disclosure relates to portable, efficient, and smart solar refrigeration units able to be easily deployed and monitored.

Maintaining a proper temperature for harvested seafood in the seafood industry is critical to maintain freshness and quality of products such a fish and shellfish. In many cases, ice in a cooler, small to industrial scale, can be used. However, this can be expensive, imprecise, and lead to melting and wetting of the seafood. Further, in many cases ice leads to freezing of tissue and/or killing live shellfish reducing quality. Accordingly, many in the seafood industry have turned to more precise refrigeration units, often called “chillers” or “reefers.” However, typical refrigeration units use refrigeration evaporator/condensers which require a large amount of electricity to operate. In remote locations such as fishing vessels, as well as markets, events, and the like, such electricity must come from highly inefficient combustion engines such as a vehicle motor or generator. These electricity sources are also loud, smell, and have a substantial carbon footprint.

Therefore, what is needed is a refrigeration unit that is efficiently operable in remote locations without relying on fossil fuel for operation.

### SUMMARY OF THE INVENTION

The subject matter of this application may involve, in some cases, interrelated products, alternative solutions to a particular problem, and/or a plurality of different uses of a single system or article.

In one aspect, a refrigeration unit is provide. The refrigeration unit has a body which defines an interior space into which items may be stored for refrigeration. A chiller is in communication with the interior space and is operable to lower a temperature within the interior space. The chiller is powered by a battery of the refrigeration unit. A solar panel is removably attached to the body and in electronic communication with the battery so as to charge the battery. In addition to the solar panel, the refrigeration unit has a corded power input to e.g. an AC power plug or source. The refrigeration unit has a plurality of sensors for monitoring system parameters such as a sensor in communication with the battery to measure charge state, charge rate, and the like; a sensor in communication with the solar panel to monitor its operation such as electricity production, and a sensor in the interior space of the body to monitor temperature, among other features. Further still, the refrigeration unit is equipped with a GPS unit for location monitoring and tracking. The device is equipped with wireless communication devices that are able to wirelessly send and receive information such as sending sensor information and receiving operational instructions and parameters, referred to herein as transceivers. In a further aspect, the refrigeration unit may have a charge controller. The charge controller is operable to selectively control a charge of the battery using electrical input from one or both of the solar panel and the corded power input. The charge controller may be operable to charge the battery and operate the chiller simultaneously, the chiller drawing electrical power directly from the battery only, or may be operable to charge the battery and operate the chiller simultaneously, among other operational states and features as discussed below.

In further aspects, the refrigeration unit may be in communication with a remote computerized user interface. The computerized user interface system comprises a processor, memory, and user interface allowing display of data from the one or more transceivers of the refrigeration unit, and allowing user input of instruction to send to the one or more transceivers. In one aspect, the processor of the computerized user interface system may be operable to receive data from the one or more transceivers from the plurality of sensors, and operable to display sensed data based on the received data on the user interface. In another aspect, the processor of the computerized user interface system is operable to send an instruction to the chiller to activate the chiller.

In another aspect, a method of operation of a solar powered refrigeration unit is provided. The method involves placing a solar panel of a solar powered refrigeration unit in sunlight. The solar panel may be connected to the refrigeration unit body, or separated therefrom and connected by a cable. The solar panel operates to charge a battery of the solar powered refrigeration unit and in some embodiments may directly power the operational components of the refrigeration component. Items are placed into the interior space of the refrigeration unit to be kept cold. A temperature is set using a remotely connected computerized user interface system. Location of the refrigeration unit is monitored, along with a plurality of other refrigeration units, using the computerized user interface system. In a particular aspect, the computerized user interface may instruct a user to properly position the solar panel. This may include adjusting, based on calculations performed by the computerized user interface system, a position of the solar panel so as to direct the solar panel toward the sun. This maximizes solar panel electricity generation. Instruction through the user interface may be in the form of written or visual prompts presented on the display of the computerized user interface.

### BRIEF DESCRIPTION OF DRAWINGS

FIG. 1 provides a perspective view of an embodiment of the present disclosure.

FIG. 2 provides a front view of another embodiment of the present disclosure.

FIG. 3 provides a side view of yet another embodiment of the present disclosure.

FIG. 4 provides a rear view of still another embodiment of the present disclosure.

FIG. 5 provides a front view of still yet another embodiment of the present disclosure.

FIG. 6 provides a view of an embodiment of the present disclosure in an embodiment of use.

FIG. 7 provides an inside view of one embodiment of the present disclosure.

FIG. 8 provides a schematic of one embodiment of the present disclosure.

FIG. 9 provides a schematic of another embodiment of the present disclosure.

### DETAILED DESCRIPTION OF THE INVENTION

The detailed description set forth below in connection with the appended drawings is intended as a description of presently preferred embodiments of the invention and does not represent the only forms in which the present disclosure may be constructed and/or utilized. The description sets forth the functions and the sequence of steps for constructing and operating the invention in connection with the illustrated embodiments. Units disclosed herein reflect abbreviations well known in the art. For example Volts (“V”), Amperes (“A”) and Watts (“W”).

Generally, the present disclosure concerns a refrigeration unit having a battery powered chiller which may be charged by either a solar panel or AC power source such as a wall plug. This system will allow users such as those in the seafood industry to chill items such as seafood when in remote locations in a “green” and efficient manner. In many cases, items like seafood do not need to be frozen, rather only kept chilled. This means that the energy requirements for a refrigeration unit can be reduced to keep an interior temperature at approximately 32-40 degrees Fahrenheit. This is less than other industrial chillers which reduce the temperature below freezing, requiring meaningfully higher energy and making solar and battery powered applications undesirable. In a typical embodiment, the refrigeration unit involves an insulated body which defines an interior storage space (such as, in one embodiment, 26 cubic feet) for chilled items. A chiller or other refrigeration/cooling system is in communication with the interior storage space and connected to or integrated in the body. A battery provides electrical power for operation of the chiller. A solar panel is in communication with the battery to charge the battery via a charge controller. Further, in many embodiments, an AC power cord connectable to a wall plug or other power source is in communication with the battery as an alternative charging method. In many embodiments, a computerized charge control unit (“charge controller”) is operable to prioritize solar charging of the battery even when plugged in, and is operable to supplement with AC power in embodiments when the solar panel is providing low (or no) levels of charge rate.

In some embodiments, the battery may be a 24V 100Ah LFP- with built in wireless communications to connect to a computer controller, and a battery heater. Of course, other battery embodiments may be possible. The charger may be any cable and plug able to connect to the selected battery. In one embodiment, it may be a 12A 120 v wall connection. In another embodiment, the charger may be a 24v 40A or 50A AC charger. In some embodiments, the chiller may be able to run while also charging the battery at, e.g. 15A. In non-limiting embodiment, the chiller may draw up to approximately 36A at 24V during operation. Again, as discussed throughout, all embodiments are intended to be non-limiting and different embodiment features may be interchanged with other embodiments, without straying from the scope of this disclosure. Solar panel selection may vary depending on embodiment. In one embodiment, the solar panel may be a 200W 24V solar panel. In certain embodiments, the battery may be equipped with a heater such as a heating pad, which improves battery functioning in cold weather, particularly below freezing.

In some embodiments, the battery may be a 12V battery. Such a configuration may allow existing 12V alternators of vehicles (automobiles, boats, and the like) to conveniently charge the battery of the refrigeration unit.

The insulated body of the refrigeration unit may be any insulated structure that encloses the internal storage space. In some embodiments, the bottom of the body defines channels or slots to receive forklift tines. These channels or slots may extend widthwise on the body, lengthwise on the body, or both widthwise and lengthwise. In further embodiments, the body exterior may define channels to receive straps such as tie down straps or crane-lifting straps. The internal storage space defined by the body may have slide in shelving for enhanced storage and organization. Typically, an evaporator/condenser cooling unit is used, though in some embodiments, a cold plate cooling system may be used instead of or in addition to the evaporator/condenser. In still further embodiments, a liner such as an insulating liner, and/or an ice pack liner may be removably positioned within the internal storage space. A temperature probe inside the internal storage space operates to activate the cooling unit when the temperature rises above a predetermined level. In some embodiments, the unit may be formed of a plastic material having an air gap or insulation such as foam within. In a particular embodiment, the refrigeration unit body may be formed of Edura ™ panels. Sizing of the body of the refrigeration unit may vary. In one embodiment, the body may be 66” long x 46” high x 39” wide. Such sizing fits in a typical pickup truck bed and many trailers.

In some embodiments, the refrigeration unit may be stackable, allowing multiple units to be placed one on top of the other in a stable and secure fashion. In one stackable embodiment, the body may have feet extending from a bottom. These feet are spaced to be wider and longer than the area of the solar panel on the top of the body, such that when stacked they may fit around the panel and seat onto a top surface of a body of a lower refrigeration unit. While this may result in the solar panel being shaded, it will enable higher density of transportation, particularly in situations where multiple refrigeration units are aggregated into large trucks, rail cars, planes, or other transportation systems.

Another common problem faced when storing fresh seafood and other perishable items is the concern with excessive drying out of the chilled material (i.e. seafood products). Traditional refrigeration chillers operate to circulate air which has been dehumidified during the cooling phase, leading to a very low humidity level within the chilled area. Additional drying is caused by the convective movement of the chilled air within the chilled cavity over the seafood products. As can be imagined, drying of seafood product such as fish and shellfish tissue can damage or completely ruin valuable products. Typical solutions include carefully covering or sealing the contents, but this can be error prone and is inconvenient. In some embodiments, the present disclosure solves this problem by the use of a cold plate or plates as the chiller within the internal storage space. Such cold plates chill the storage space via conductive heat exchange between the air and the cold surface of the cold plate. This allows for cold air with a high humidity and limited air circulation which in turn limits convective moisture loss from the products within the storage space.

Another problem faced with many cooling system (“chiller”) control systems is that they will not activate to cool the internal space when the ambient temperature outside is below a certain level. Typical refrigeration systems do not work well in cold environments, like a cold boat deck in winter, because when the surrounding temperature is already close to the desired cooling temperature inside, the thermostat senses that it does not need to cool further and therefore does not turn on the compressor, resulting in a lack of cooling within the internal space. To solve this problem, in many embodiment, a small heating source may be positioned adjacent to the chiller to warm it, “tricking” it to believe external ambient temperature is higher than it is, thereby activating the compressor (or other cooling component(s)).

In one embodiment, all of the operational components discussed throughout this disclosure may be integrated into a single wall, such as a top wall, cover, or lid for existing insulated storage containers. This embodiment may allow existing containers to be modified to be solar powered refrigerated containers. For example, a cooler lid may be converted in this manner, or in another example, the system may be integrated into a lid for an Xactics® container or equivalent. Xactics® containers are commonly used in the aquaculture, fisheries, and seafood industries and it may be advantageous to retrofit existing containers such as these with the refrigeration unit and related components disclosed herein.

Importantly, the present disclosure utilizes a sophisticated sensor system to both control and optimize operation, as well as to provide automated remote tracking and monitoring of the devices, power usage, charge rate from the solar panel, battery energy consumption and charge statistics, operation of the chiller, temperature within the chiller cavity, and the like. A GPS unit allows location tracking remotely, and a Bluetooth, cellular, satellite, or other wireless transmitter, receiver, and/or transceiver allows for wireless communication and monitoring. In embodiments where remote use is envisioned, such as on the water away from shore, a satellite communication option is preferred to allow for tracking and monitoring even in the most remote of locations. In many embodiments, multiple communications systems may be available for efficiency purposes, such as Bluetooth/wireless/cellular for local use, with satellite communication being reserved for more remote use cases. In some embodiments, a sensor or sensors on the solar panel is able to identify its orientation and configuration, such as an accelerometer or other sensor able to identify, e.g. angle, direction, movement, and the like.

The sensor system and other electronic systems of the refrigeration unit are operable to wirelessly communicate with a computerized user interface system via e.g. one or more transceivers. This may be in the form of a desktop computer interface, server, or mobile device. As noted above, the transceiver(s) on the refrigeration unit communicates with the various sensors and components, and is able to relay the sensed data to the computerized user interface. The user interface computer processor may be operable to present, on a display, the sensed data for interpretation by the user. Control instructions may also be sent back to the refrigeration unit via the user interface and processor of the computer, such as to adjust a set temperature, activate the cooling device, restart one or more components, and the like.

In some embodiments, a plurality of temperature sensor probes may be used to monitor not only internal temperature of the internal storage space, but also to monitor the individual products or packages therein. For example, multiple probes may be provided- wireless or on cables, that are also in communication with the computerized control system, to verify and track the temperature of the goods inside the refrigeration units.

In certain embodiments, the solar panel may be adjustable in orientation and/or removable from a body of the refrigeration unit. For example, the solar panel may be removably connected to the body of the refrigeration unit by a clip or clips, or slots, such that it can be relatively easily removed. In a further embodiment, the solar panel may be pivotally connected to the body of the refrigeration unit, allowing it to be rotated relative to the body to be efficiently directed at the sun. In another embodiment, an extendable leg may allow for the solar panel to be angled upward or downward and move relative to the body of the refrigeration unit so as to be more directly facing the sun to increase solar energy collection. The solar panel may be removable, allowing it to be placed remotely from the refrigeration unit and connected via an electrical cord. In such remote embodiments, the solar energy may be collected while the refrigeration unit is in a location not in the sun, such as inside a fishing vessel, within a van or trailer, under a tent, and the like. In some removable embodiments, an adjustable arm may allow for angling of the solar panel to allow it to face the sun. The adjustable arm may adjust in length to achieve an optimal orientation, and/or may fold away when a flat configuration is desired.

As noted above, the system may further include a computerized system and user interface in communication with components of the refrigeration unit. In one embodiment, a computerized interface may be programmed to identify a location of the solar panel using a GPS receiver positioned on the solar panel or elsewhere on the refrigeration unit. Based on this location, the computerized system may calculate an optimal angle and orientation of the solar panel to be directed at the sun. This calculated position may be presented on a display of the computerized user interface, thus instructing a user on how to position the solar panel. In a further embodiment, a position sensor on the solar panel is able to identify orientation of the solar panel, such as, e.g. one or more accelerometers. The position sensor (or other sensor able to monitor positioning of the solar panel) may be in wireless communication with the computerized system to provide dynamic and/or real-time feedback to a user as to proper positioning. For example, the user interface display may indicate that a rotation in one direction and/or angle adjustment is needed, and provide a visual indication of what this rotation/angle change is. Once a calculated ideal position is achieved (within reasonable tolerance), the user interface display may indicate as such via visual and/or audible/haptic feedback. In another similar embodiment, a sensor measuring electricity generation by the panel may be used to instruct optimal positioning based on an electricity generation rate relative to movement of the panel.

In a further embodiment, in addition to the cooling system (referred to as a chiller herein), the refrigeration unit may also have a heater. The heater is operable to provide heat to the insulated space within the refrigeration unit in cases when the ambient temperature is below freezing, in order to prevent contents from freezing. For example, oysters may be stored in the refrigeration unit in wintertime, and the heater may operate to prevent the internal temperature from dropping too low, thus freezing the oysters. This may also be advantageous for other live seafood, and to prevent fresh seafood from freezing, which can negatively impact flavor and texture.

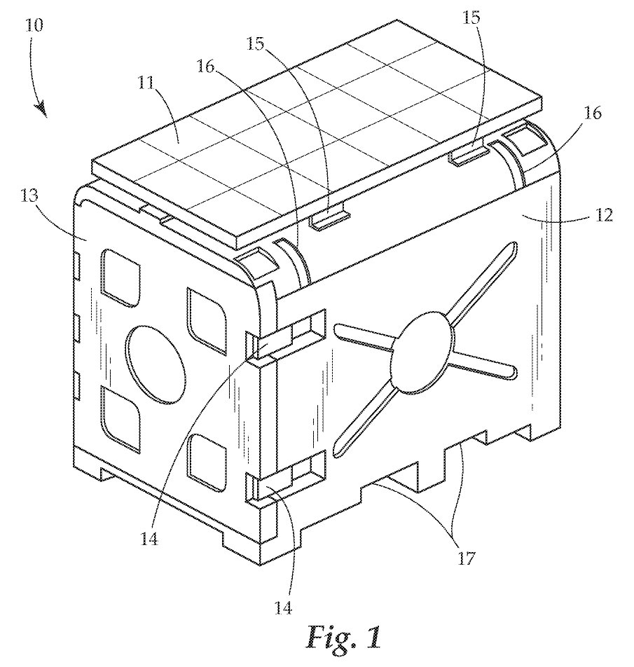

Turning now to FIG. 1, an embodiment of the refrigeration unit is provided. The refrigeration unit 10 has a body 12 formed of insulated walls and a door 13. In the embodiment shown, door 13 is held closed by latches 14 but of course any closure may be used. In some embodiments, a lock such as a keyed lock or padlock may be used. Forklift tine slots 17 can be seen on the bottom of the body 12 extending in a widthwise direction. In this embodiment, there are also forklift tine slots extending from front to rear in a lengthwise direction, but are not visible in this view. On the corners are indented slots 16 which serve to guide tie-down straps or crane lift straps and limit their sliding laterally along the body 12. The refrigeration unit 10 has a solar panel 11 mounted thereto. In this embodiment, the solar panel 11 is held to the body 12 by flexible clips 15. These clips 15 are formed of metal and can flex or deform to allow the removal of the solar panel 11 from the body 12 for applications as discussed above.

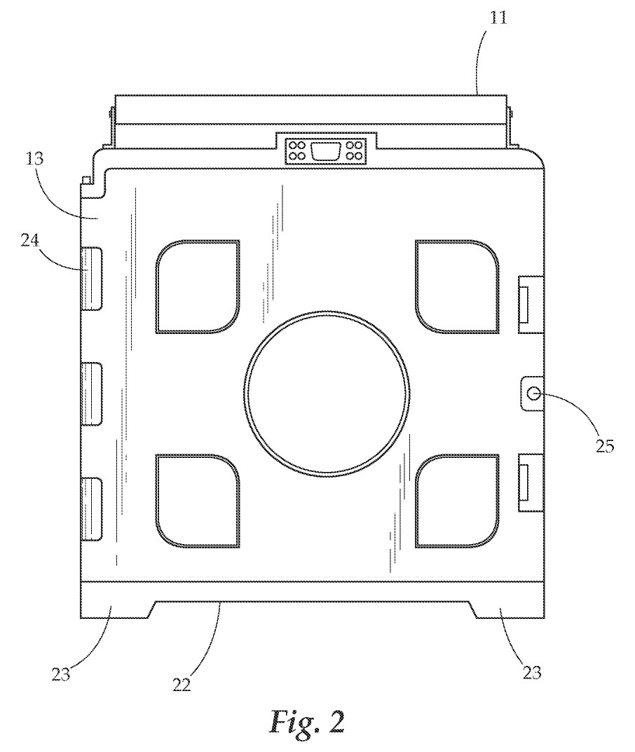

FIG. 2 shows another embodiment of the refrigeration unit from a front view. In this view, the lower feet 23 and slot 22 therebetween to receive forklift tines can be seen. This view also shows lock 25, shown here as a keyed lock, but of course could be any other locking configuration. Door 13 opens via hinge 24. A controller interface 21 is present on the front top of the device. The controller interface allows simple status display such as internal set temperature, and adjustments such as temperature set, operational status, on/off control, and the like.

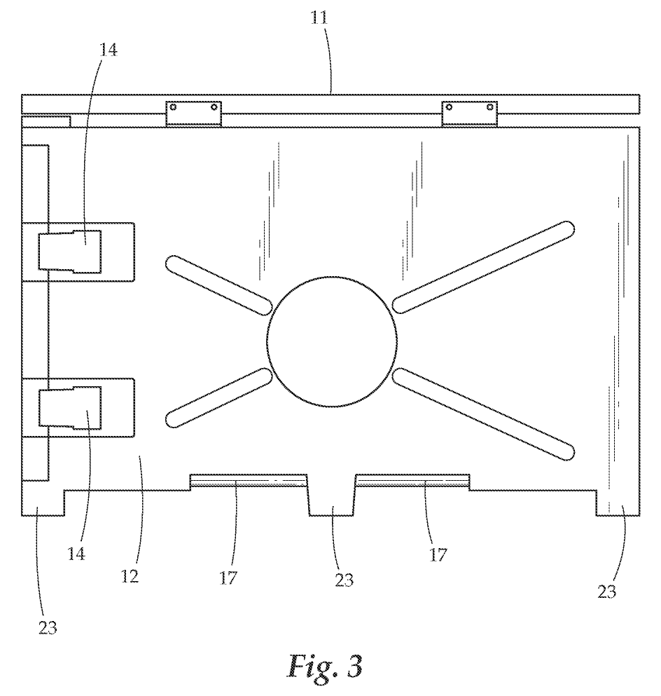

FIG. 3 provides a side view of an embodiment of the refrigeration unit. Body 12 defines hand-sized channels adjacent to the clips 14 to allow for easy access. The solar panel 11 is mounted to the top of the body 12. At the bottom are three legs 23 which define two slots 17 to receive forklift tines. This allows for easy lifting and transport of the device.

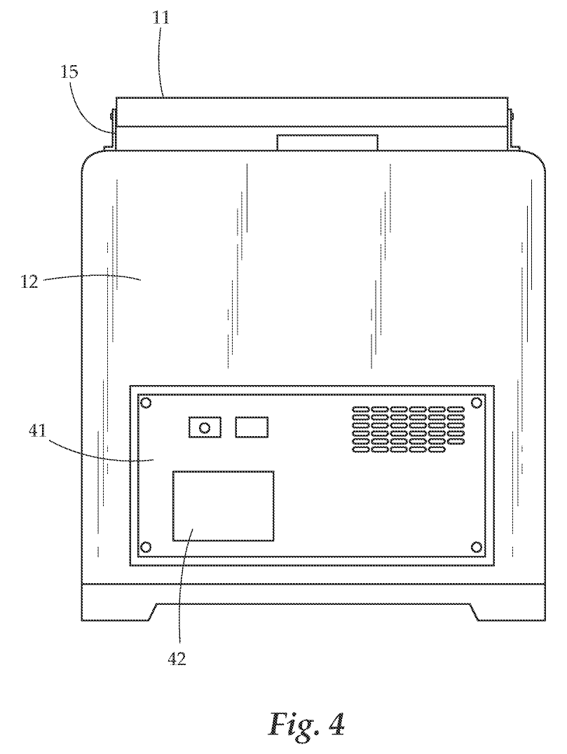

FIG. 4 provides a rear view showing the chiller components of the refrigeration unit. Chiller, 41 is powered by battery 42 and both are connected to the body 12. A portion of the chiller 41 extends into the interior storage area of the body 12 to provide cool air or surfaces within. The battery 42 powers the chiller 41 and is in communication with solar panel 11 to be charged by it, as well as by the AC power inlet 42 when plugged in.

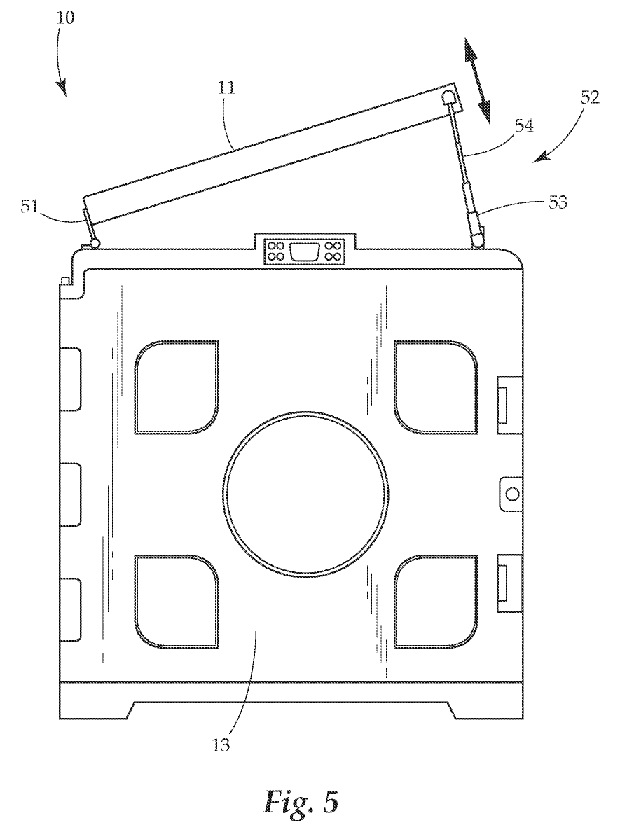

FIG. 5 provides a view of an embodiment of adjustability of the solar panel of an embodiment of the present disclosure. In this frontal view, the door 13 can be seen and the solar panel 11 is attached to the refrigeration unit 10 body 12 by connectors 51 and 52. Leg connector 52 is extendable via, for example, a telescoping assembly 53, 54. Preferably the extendable leg connector 52 will hold or lock the leg in the extended position to support solar panel in an angled configuration. This allows a user to best optimize orientation of the solar panel in increase the energy captured from the sun. In further embodiments, as indicated by pivoting arrows, the solar panel 11 may pivot relative to the body 10 so that, when angled, it may face the front, sides, rear, and other angles therebetween to be directed properly at the sun. Such a configuration may allow for precise control of pivoting may be achieved via a ball bearing coupling, or multiple adjustable leg connectors, among other options. In some embodiments, a sensor may be positioned on one or both of the extendable leg and the pivot bearing, wherein the sensors are able to determine angle and pivot direction based on these sensors. Sensors, like other sensor systems disclosed herein, may be in remote communication with a computerized user interface system to display solar panel status. In a further embodiment, an actuator may be positioned in engagement with the extendable leg and/or pivot bearing. The actuator may be in communication with the transceiver and can receive input from the remote computerized system user interface. Accordingly, a user or the operational computer may automatically or manually remotely change configuration of the solar panel to face it toward the sun.

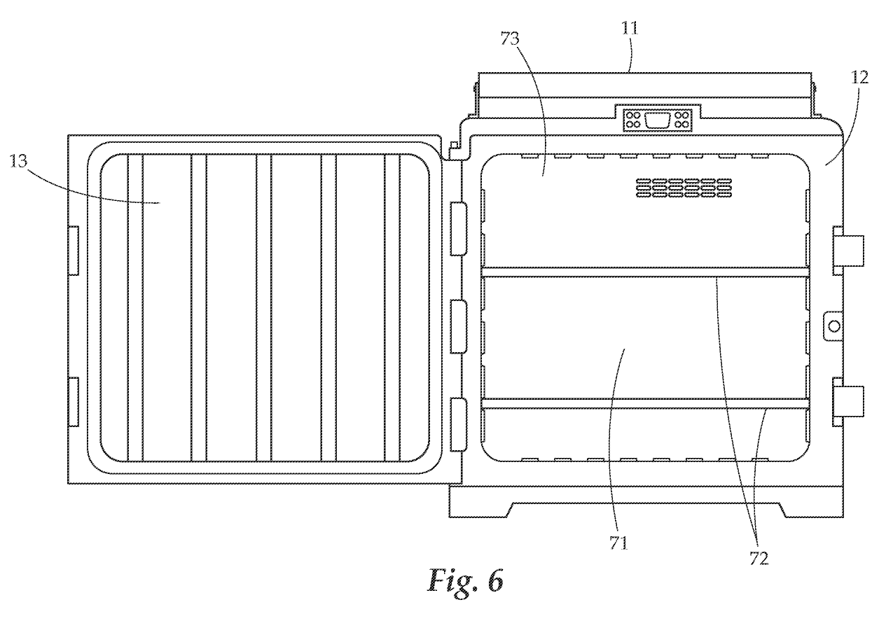

FIG. 6 provides a view of another embodiment of the present disclosure having a removable solar panel. In this view, solar panel 11 may physically disconnect and be separated from the body 12 and is connected to the battery (not shown) by charge cord 61. In this view, the solar panel 11 has an extendable support leg 53 which can pivot from a closed position flush against the solar panel 11 to an extended position, and various positions in between. The support leg 53 may also extend in length to adjust for angle and orientation, allowing the solar panel 11 to be angled towards the sun. Such an embodiment having removable solar panel 11 allows the body 12 to be in a non-sunny location such as under a tent at a market, within a cargo hold or interior space of a vehicle or boat, and the like, while still capturing solar energy to charge the battery and power the chiller.

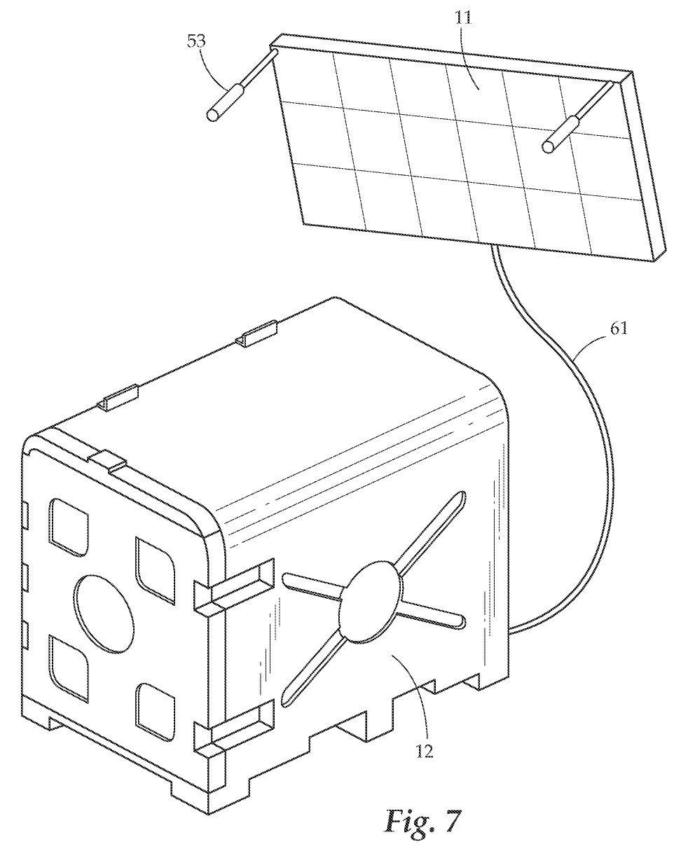

FIG. 7 provides a view of an open front of the refrigeration unit. The door 13 opens to expose an internal storage space 71. A plurality of racks 72 fit in slots or channels. Chiller 73 extends into the storage space 71 and provides cool air or cool surfaces to chill the internal storage space 73. Other cooling units may also be used without straying from the scope of this invention, including cold plates, and the like.

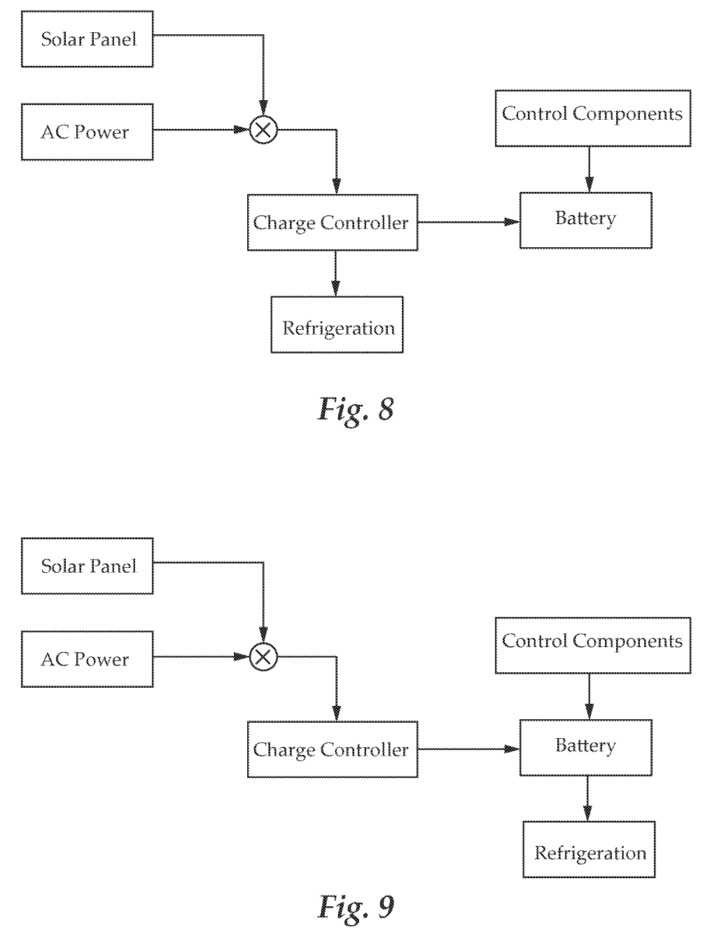

FIG. 8 provides a view of a novel charge controller and related operational features. The refrigeration unit of the present disclosure may include a unique charge controller which is operable to intelligently prioritize electric power from solar panel to charge the battery, supplementing the solar panel partially or fully from an AC power source when the refrigeration unit is plugged into an outlet. As such, power may flow from the solar panel to the charge controller, and from the AC power to the charge controller. In some embodiments electricity may flow to the charge controller on a combined input controlled by a switch, or the battery and AC power source may each directly connect with the charge controller. The charge controller may then direct electric flow to charge the battery- again prioritizing charging from the solar panel, and supplementing only if needed and to a minimal extent possible with the AC power source.

The battery provides power to control components such as sensors within the refrigeration unit, readouts and displays as well as any input/output systems- referred to generally as control components. For example, in one embodiment configured to maximize battery charge speed, if 80% of max charge rate of the battery is being provided by the solar panel, the remaining 20% may be provided by the AC power. In another different embodiment configured to maximize clean solar power, the charge controller may only use AC power to charge the battery when the solar panel electricity flow is below a predetermined threshold (or if at 0). The charge controller is a combination of a programmed and programmable processor, along with a memory and interface device such as a user interface, as well as at least one switch or a plurality of switches and other electrical components operable to control, direct, and/or throttle electrical input to the battery. The charge controller includes wireless communication components such as one or more transceivers, or is in communication with the wireless communication components of the refrigeration unit. This allows the charge controller to provide data regarding charge statistics, sources, operation, and the like. It also allows a user interface of the computerized control system to provide operational input/instruction to the charge controller to, among other things, optimize charge rate, optimize solar input rate, set charge time, and so forth.

In the embodiment of FIG. 8, the charge controller also directly controls power flow to the electrical refrigeration unit. This allows the charge controller to selectively power the refrigeration unit from the battery, AC power and/or solar panel, and also allows it to concurrently charge the battery and operate the refrigeration unit using input from one or both of the solar panel or AC power. For example, typically the refrigeration unit is operated periodically, cooling the refrigerated space for a period, for example, until a set temperature is reached. The unit then powers down until it is needed again. In this case, the battery may be charged at all times except when the refrigeration unit is being used.

In still a further embodiment, the charge controller may be programmed, based on input from the computerized user interface system, to fully charge the battery by a predetermined time. In such an embodiment, the charge controller may receive the set time and calculate time and energy needed to charge, and calculate the required rate of charge needed. The required AC power input, if any, can then be controlled, giving preference to solar charging if possible. The processor of the control unit may also be in electronic communication with a weather service, for example via the transceiver on the refrigeration unit, to identify expected amounts of sun and solar energy at the detected location (using the GPS receiver on the refrigeration unit) for purposes of planning the charge time and rate. In still a further embodiment, the user interface may instruct a user to orient the solar panel in a direction facing the sun, to optimize charge rate and efficiency. For example, if a great deal of time remains before the set charge time the charge controller can plan to charge exclusively with the solar panel. However, if a short time remains before the set charge time, the AC power source may be used in conjunction with the solar panel to maximize charge rate.

FIG. 9 provides another embodiment of controller configuration. In this view, the refrigeration unit is directly powered by the battery only, and the charge controller provides flow to the battery. The system may have the same or similar operability as noted above. In this embodiment, all incoming electricity goes to the battery which in turn may power the refrigeration unit. This may provide efficiency and simplicity advantages in some cases, though allows for less sophisticated operational control which may be desirable in some use cases. It also allows for battery charging simultaneously with the operation of the refrigeration unit.

While several variations of the present disclosure have been illustrated by way of example in preferred or particular embodiments, it is apparent that further embodiments could be developed within the spirit and scope of the present disclosure, or the inventive concept thereof. However, it is to be expressly understood that such modifications and adaptations are within the spirit and scope of the present disclosure, and are inclusive, but not limited to the following appended claims as set forth. It should also be understood that any component, element, or feature discussed with respect to one embodiment may be interchangeable with any other embodiment and may be combined into embodiment having other disclosed components, elements, or features, without straying from the scope of this disclosure.

What is claimed is:

1. A refrigeration unit comprising:
a body defining an interior space;
a chiller in communication with the interior space operable to lower a temperature within the interior space;
a battery in electronic communication with the chiller;
a solar panel attached to the body, the solar panel in electronic communication with the battery;
an corded power input to the battery;
a plurality of sensors, the plurality of sensors comprising a first sensor in communication with the battery, a second sensor in communication with the solar panel, a third sensor in communication with the interior space of the body;
a GPS unit;
one or more transceivers in communication with the plurality of sensors and the GPS unit, the one or more transceivers operable to provide wireless communication to the plurality of sensors.

2. The refrigeration unit of claim 1 wherein the solar panel is removable from the body.

3. The refrigeration unit of claim 1 wherein the one or more transceivers is in communication with a computerized user interface system, the computerized user interface system comprising a processor, memory, and user interface allowing display of data from the one or more transceivers, and allowing user input of instruction to send to the one or more transceivers.

4. The refrigeration unit of claim 3 wherein the processor of the computerized user interface system is operable to receive data from the one or more transceivers from the plurality of sensors, and operable to display sensed data based on the received data on the user interface.

5. The refrigeration unit of claim 4 wherein the processor of the computerized user interface system is operable to send an instruction to the chiller to activate the chiller.

6. The refrigeration unit of claim 1 further comprising a charge controller, the charge controller operable to selectively control a charge of the battery using electrical input from one or both of the solar panel and the corded power input.

7. The refrigeration unit of claim 4 further comprising a charge controller, the charge controller operable to selectively control a charge of the battery using electrical input from one or both of the solar panel and the corded power input, and wherein the processor of the computerized user interface system is operable to receive an input from the user interface and send a signal, via the one or more transceivers, to control an operation of the charge controller.

8. The refrigeration unit of claim 1 further comprising a liner removable attached to a wall of the interior space of the body.

9. The refrigeration unit of claim 1 wherein the solar panel is attached to the body by an extendable leg, the extendable leg extending and retracting to adjust an angle of the solar panel relative to a top surface of the body.

10. The refrigeration unit of claim 9 wherein the solar panel is connected to the body by a pivot bearing and pivotable relative to the body.

11. The refrigeration unit of claim 10 wherein the plurality of sensors further comprises a sensor in communication with the extendable leg to determine an angle of the solar panel with respect to the top surface of the body, and a sensor in communication with the pivot bearing to determine the position of the solar panel relative to the body.

12. The refrigeration unit of claim 11 wherein the processor of the computerized user interface system is operable to receive an input from the sensor in communication with the extendable leg, and the sensor in communication with the pivot bearing, and the processor is operable to provide an instruction display on the user interface instructing a user to adjust a position of the solar panel to direct the solar panel to the sun.

13. The refrigeration unit of claim 1 wherein the chiller, battery, solar panel, corded power input, GPS unit, and one or more transceivers are on or in a cover of the body.

14. The refrigeration unit of claim 1 wherein the solar panel is connected to the body by a plurality of flexible clips.

15. The refrigeration unit of claim 1 wherein a bottom of the body defines a first set of forklift slots extending lengthwise across the body, and a second set of forklift slots perpendicular to the first set of forklift slots extending widthwise across the body.

16. The refrigeration unit of claim 1 further comprising a heater in communication with the interior space.

17. The refrigeration unit of claim 1 wherein the heater is programmed to activate when the temperature within the interior space drops below a predetermined temperature to prevent items within the refrigeration unit from freezing.

18. The refrigeration unit of claim 6 wherein the charge controller is operable to charge the battery and operate the chiller simultaneously.

19. The refrigeration unit of claim 6 wherein the charge controller is operable to charge the battery and operate the chiller simultaneously, the chiller drawing electrical power directly from the battery only.

20. A method of operation of a solar powered refrigeration unit comprising the steps of:
placing a solar panel of a solar powered refrigeration unit in sunlight;
placing items within an interior space of a body of the refrigeration unit;
setting a temperature within the interior space using a remotely connected computerized user interface system;
monitoring a location of a plurality of refrigeration units using the computerized user interface system; and
adjusting, based on calculations performed by the computerized user interface system, a position of the solar panel to direct the solar panel toward the sun to maximize solar panel electricity generation.
